(19) United States
(12) Patent Application Publication
(10) Pub. No.: US 2018/0293600 A1
(43) Pub. Date: Oct. 11, 2018

(54) COLD PART LOAD AND PEAK FIRE OPPORTUNITIES

(71) Applicant: General Electric Company, Schenectady, NY (US)

(72) Inventors: Jonathan Carl Thatcher, Pendleton, SC (US); Marc Gavin Lindenmuth, Atlanta, GA (US); Frederick Block, Campobello, SC (US)

(21) Appl. No.: 15/483,574

(22) Filed: Apr. 10, 2017

(51) Int. Cl. G06Q 30/02; G06Q 50/06; G06Q 10/00; G06Q 40/04

(52) U.S. Cl. CPC G06Q 30/0206; G06Q 40/04; G06Q 10/20; G06Q 50/06

(57) ABSTRACT

An architecture and techniques for determining operation of energy-producing equipment that can increase profitability are presented. Such can be surfaced in easily understood financial market paradigms that reflect relatively complex physical models associated with the equipment. For example, buy data and sell data can be presented that reflect determined buy opportunities and determined sell opportunities. The buy opportunities can represent conditions in which it is advised to operate the equipment according to a cold part load protocol and the sell opportunities can represent conditions in which it is advised to operate the equipment according to a peak fire protocol.

### TECHNICAL FIELD

This disclosure relates generally to controlling energy (e.g., electricity) production machinery or related equipment or devices.

### BACKGROUND

Electricity-producing machines, such as those that burn natural gas or other fuel, can operate to produce electricity. Such equipment can be controlled to burn fuel at different temperatures, which can have different results. Today, most such machinery are controlled to burn fuel at a nominal temperature, which is typically determined to optimize the amount of electricity generated per unit of fuel consumed. In that way, energy production facilities can minimize some of the expenses (e.g., fuel costs) associated with generating electricity.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with a non-limiting, example implementation, a system can include a user interface component. The user interface component can receive a first portion of input data comprising profit margin data that represents a threshold profit margin. The system can further include a data component that receives a second portion of input data. The second portion can comprise period data that represents a defined period of time and market data representing prices for energy over the defined period of time. The system can further include a pricing component that determines buy data and sell data based on the market data and the profit margin data. The buy data can represent a first price of energy below which it is advised to operate equipment of an energy production facility according to a cold part load protocol that specifies the equipment is to operate below a nominal temperature. The sell data can represent a second price of energy above which it is advised to operate the equipment according to a peak fire protocol that specifies the equipment is to operate above the nominal temperature.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example system that can determine buy and sell data that reflect financial opportunities based on underlying operational characteristics of energy-producing equipment according to one or more embodiments of the subject disclosure;

FIG. 2A illustrates an example diagram that depicts non-limiting examples of input data according to one or more embodiments of the subject disclosure;

FIG. 2B illustrates an example diagram that depicts non-limiting examples of market data according to one or more embodiments of the subject disclosure;

FIG. 3 illustrates various example graph diagrams that depict, inter alia, temperature profiles and wear profiles of energy-producing equipment according to one or more embodiments of the subject disclosure;

FIG. 4 illustrates an example graph that illustrates an example profit-loss profile that compares operating equipment based on nominal temperatures to operation based on the buy and sell data according to one or more embodiments of the subject disclosure;

FIG. 5 illustrates an example system that can provide various visualization of output data and can optionally control energy production equipment according to one or more embodiments of the subject disclosure;

FIG. 6 illustrates an example graph that illustrates market-based electricity prices and determined equipment operation triggers according to one or more embodiments of the subject disclosure;

FIG. 7 illustrates an example visualization that illustrates sorted market-based electricity prices, sorted cost data, and projected profits according to one or more embodiments of the subject disclosure;

FIG. 8 depicts a flow diagram of an example method for determining buy and sell data that reflect financial opportunities based on underlying operational characteristics of energy-producing equipment according to one or more embodiments of the subject disclosure;

FIG. 9 depicts a flow diagram of an example method for providing additional aspect or elements in connection with determining buy and sell data according to one or more embodiments of the subject disclosure;

FIG. 10 is a schematic block diagram illustrating a suitable operating environment; and

FIG. 11 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure might be practiced without these specific details, or with other methods, components, materials, etc. In other instances, well-known structures and devices are shown in block diagram form to facilitate describing one or more aspects.

Systems and techniques for controlling energy-producing equipment to take advantage of potential cold part load opportunities and potential peak fire opportunities. For example, today, most energy-producing equipment (e.g., a gas turbine device or another industrial generator) is controlled to burn fuel at a nominal temperature, which is typically determined to optimize the amount of electricity generated per unit of fuel consumed. By operating the equipment at the nominal temperature, electricity production facilities can minimize some of the expenses (e.g., fuel costs) associated with generating electricity.

In most cases, the same equipment can be operated at a lower temperature as well, which can generate the same amount of electricity albeit by consuming more fuel than is consumed when operating at the nominal temperature. Operating the equipment at a lower than nominal temperature is referred to herein as “cold part load”, “cold part load protocol”, or similar. Despite the additional costs, due to additional fuel consumption, that is associated with operating equipment according to cold part load, one advantage can be that the equipment, or parts thereof, used to generate electricity according to a cold part load protocol will typically experience less wear than will the same equipment being operated at nominal temperatures.

In contrast to cold part load, equipment can also be operated at temperatures higher than the nominal range(s). Such is referred to herein as “peak fire”, “peak fire protocol”, or similar. Operating equipment according to a peak fire protocol will generally cause the equipment to wear out faster than operation at nominal temperatures and consumes more fuel, but as a trade-off, the equipment can produce more energy or produce energy at a faster rate.

Based on the above, certain opportunities can arise. For example, consider the case where equipment of an energy-production facility is operated according to a cold part load protocol (e.g., reducing equipment wear). Consider further that at some later (or prior) time the equipment is operated according to a peak fire protocol (e.g., increasing wear) such that net change of wear on the equipment over the life of the equipment or some other period nets to zero. In such cases, a maintenance schedule or an expected equipment or part life can be the same as if the equipment was operated at nominal temperatures over the entire period.

In other words, without change to a maintenance schedule, the equipment can be operated according to cold part load some of the time and peak fire at other times, while the estimated wear on the equipment can be substantially similar to operating the device entirely according to nominal temperature protocols. The times of operation according to cold part load or peak fire can be selected to be advantageous, for instance, the type of operation can be selected to increase potential profits of the energy production facility, potentially without any commensurate increase to wear on the equipment.

For example, suppose grid conditions are operating according to part load or a price of electricity is relatively low. During such times, it can be advantageous to operate energy-producing equipment according to the cold part load protocol. Additional fuel costs are likely to arise, but such operation effectively saves up or ‘banks’ equipment wear that can be used to create peak fire opportunities. Hence, consider some time later in which grid conditions indicate full load and energy prices soar. During these latter times, the banked equipment wear can be consumed by operating the device according to the peak fire protocol.

Based on these and other concepts, the disclosed subject matter can relate to providing various recommendations associated with operating or managing energy-producing equipment. The disclosed subject matter can also facilitate bridging the gap between physics or engineering paradigms that tend to dominate operation of energy-producing equipment and economic market paradigms to which energy trading actors are more accustomed. For example, this disclosure details a hypothetical financial instrument referred to herein as a “spark option” or similar, which can be thought of as an option (e.g., a well-known financial instrument) on an energy price or an instrument that is a function of energy price, such as the actively traded spark spread or another pricing mechanism or exchange.

Subject matter disclosed herein can, based on certain inputs, generate a buy price, a sell price, and other data, which can have conceptual elements that are analogous to options market concepts. For example, the buy price can represent a price at or below which it can be advised to operate energy-producing equipment according to a cold part load protocol. Since such operation can increase costs of operation (e.g., by using more fuel), conceptually, that increased cost can be considered analogous to a strike price associated with purchase of an option or a commission paid to a broker associated with purchase of a financial instrument. Further, operation according to the cold part load protocol can reduce wear on the equipment, which can effectively offset, in terms of wear or equipment life, subsequent (or prior) operation of the equipment according to the peak fire protocol. Hence, the sell price can represent the market price of energy at or above which it can be advised to operate the equipment according to the peak fire protocol.

In financial market terms, the buy price can represent or have an economic effect similar to buying an option. For instance, there is some cost associated with the ‘purchase’ and there is a risk of loss associated with the ‘purchase’. The sell price can represent or have an economic effect of selling the option or exercising the option, ideally, at a price that is above a breakeven price or yields a profit, potentially with leverage that is typically associated with options trading.

In engineering terms, the buy and sell prices can represent recommendations for operating the energy-producing equipment according to distinct operating protocols (e.g., cold part load, peak fire, nominal) that can respectively increase equipment life, sacrifice equipment life, or result in nominal wear.

To further the analogy, it is understood that financial instruments tend to have two transactions, an opening transaction (e.g., a buy) and a closing transaction (e.g., a sell), and in the case of options, expiration can be thought of as a sell since such closes the transaction. Similarly, for each unit of equipment wear that is mitigated, e.g., via operation according to cold part load, a commensurate unit of wear can be sacrificed at a different time, e.g., via operation according to peak fire. Hence, in financial market terms, an expiration date of a spark option can be derived from an estimated equipment life, a maintenance schedule, or some other suitable time. In engineering terms, the operator of the equipment can understand that, in spite of different operating protocols that either positively or negatively affect equipment wear or equipment life, no changes to a maintenance schedule of the equipment are typically needed.

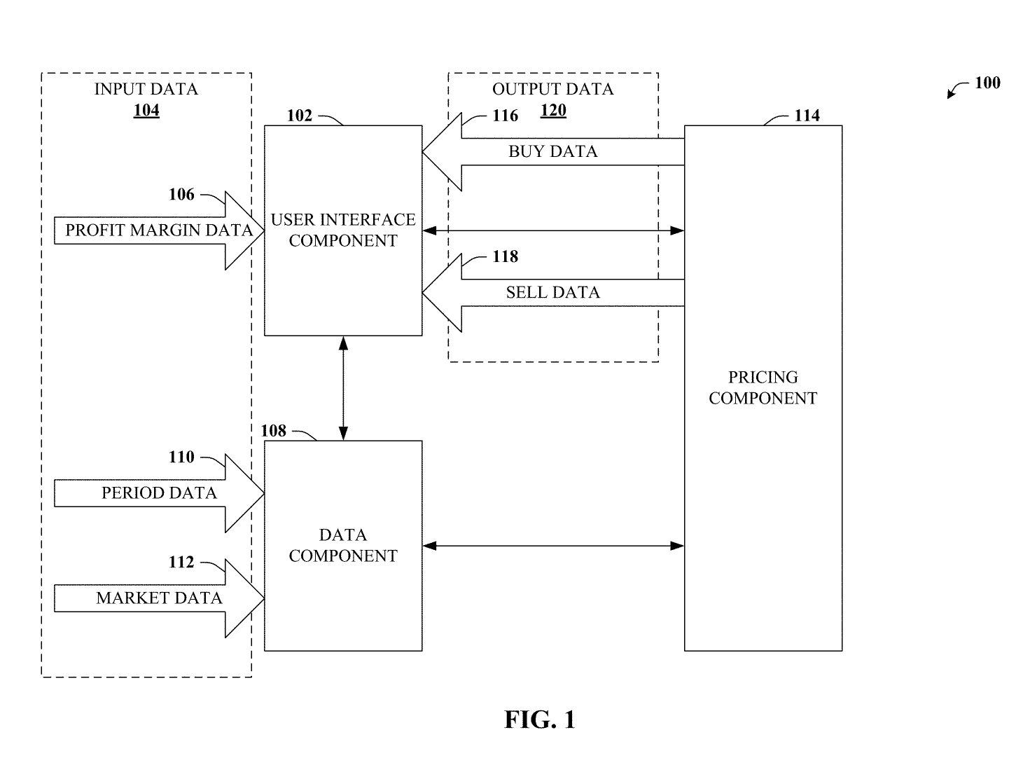

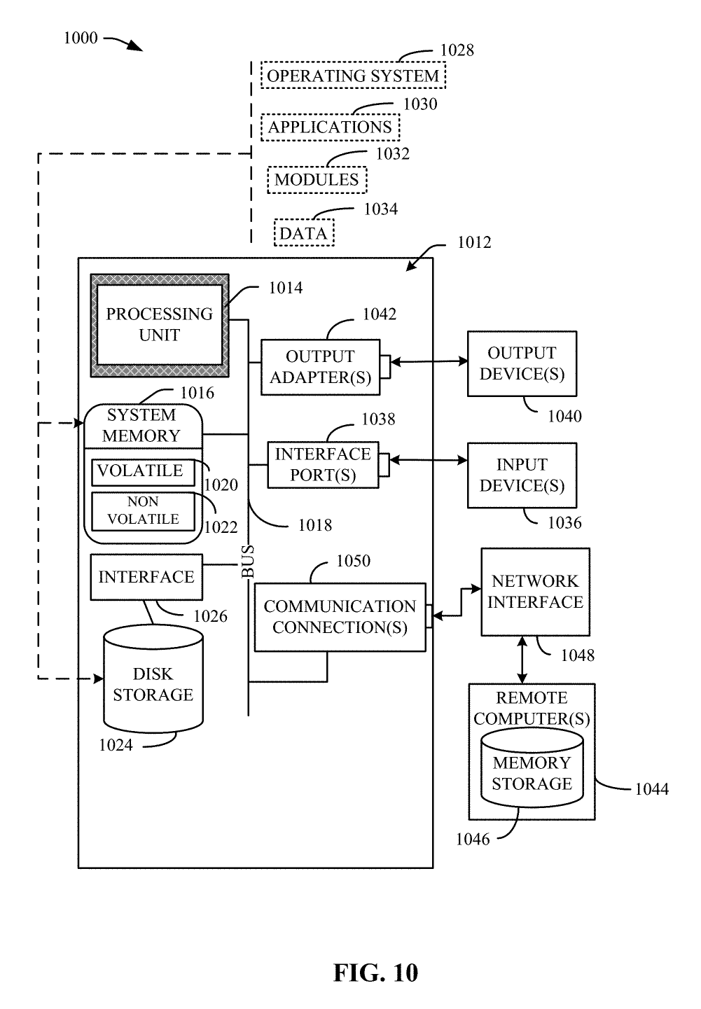

Referring initially to FIG. 1, there is illustrated an example system 100 that can determine buy and sell data that reflect financial opportunities based on underlying operational characteristics of energy-producing equipment according to one or more embodiments of the subject disclosure. Generally, systems (e.g., system 100) detailed herein can comprise a processor and a memory that stores executable instructions. The instructions, when executed by the processor, can facilitate performance of operations detailed herein. Examples of the memory and processor can be found with reference to FIG. 10. It is to be appreciated that the computer 1012 can represent a server device of a communications network or another suitable computing device and can be used in connection with implementing one or more of the systems or components shown and described in connection with FIG. 1 and other figures disclosed herein. Moreover, system detailed herein or components thereof can be employed to use hardware and/or software to solve problems that are highly technical in nature (e.g., related to operating energy producing equipment, etc.), that are not abstract and that cannot be performed as a set of mental acts by a human. For example, in some embodiments, certain determinations performed by components detailed herein can be based on very large data sets that mental acts by a human cannot solve sufficiently quickly to be as useful as otherwise. Furthermore, in some embodiments, certain solutions or determinations of components detailed herein can provide significant improvements to certain technological fields or domains such as technological domains relating to energy-producing equipment or facilities.

System 100 can include user interface component 102 that can receive a first portion of input data 104. The first portion of input data 104 can be, e.g., profit margin data 106. Profit margin data 106 can represent a threshold profit margin, for instance, a minimum profit margin or return that is specified on certain financial or economic transactions, some of which are described below. By way of illustration and not limitation, a user can input 30% as a desired profit margin. In that case, profit margin data 106 can be representative of the value 30% and can indicate that certain computations are to be determined based on that value.

System 100 can further include data component 108 that can receive a second portion of input data 104. The second portion of input data 104 can comprise, e.g., period data 110 and market data 112. Period data 110 can represent a defined period of time (e.g., three months, a year, two years, or another suitable time). In some embodiments, period data 110 can reflect a maintenance schedule or a part life of energy-producing equipment. For example, if certain equipment has an expected life of 32,000 factored fired hours, or is scheduled to be serviced in three years, then period data 110 can represent a forward time period representative of those values or some portion thereof. In that case, period data 110 can represent a range of time from a current time or date to the next scheduled servicing of the energy-producing equipment or some portion of that time range.

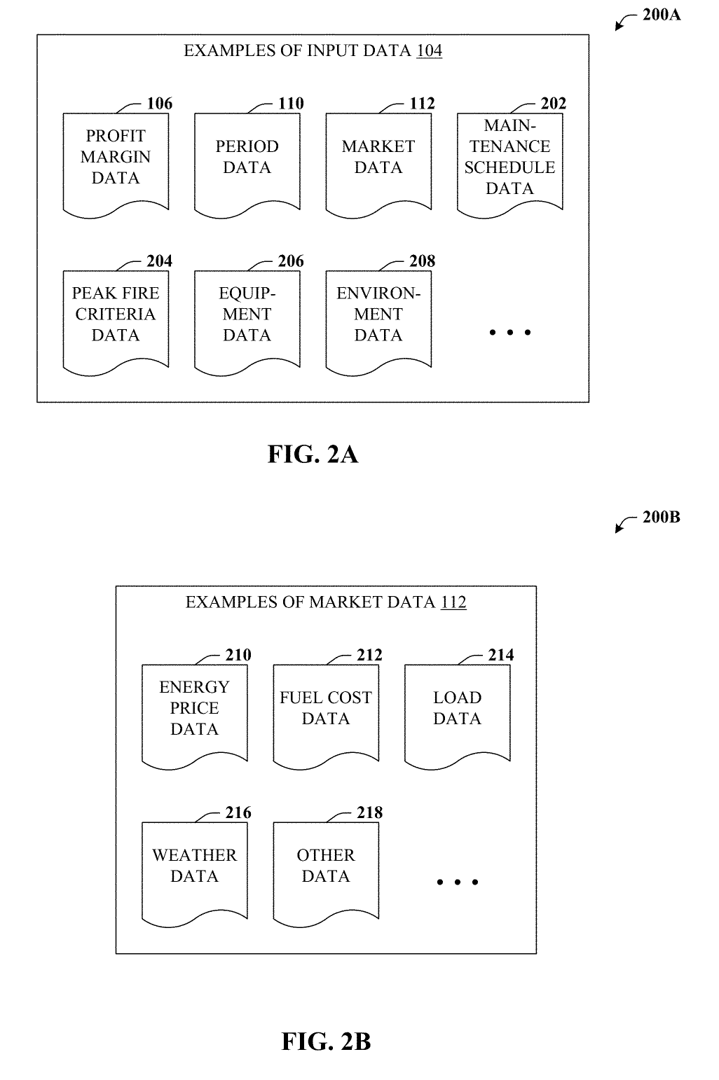

Market data 112 can represent prices for energy over the defined period as well as other relevant data relating to the production of energy. Market data 112 can reflect current values, forecasted values, or historic values. As one example, market data 112 can include values or other data relating to electricity market prices such as a spark spread. In other words, in some embodiments, market data 112 can represent a current price of electricity, a forecasted price of electricity, an historic price of electricity, and so forth. Various non-limiting examples of input data 110 and market data 112 are provided in connection with FIGS. 2A and 2B, which are intended to be viewed in connection with FIG. 1.

While still referring to FIG. 1, but turning now as well to FIGS. 2A and 2B, numerous examples of certain data detailed herein is described. With specific reference to FIG. 2A, diagram 200A depicts non-limiting examples of input data 104 according to one or more embodiments of the subject disclosure. As already detailed, input data can include profit margin data 106, period data 110, and market data 112. In some embodiments, input data can include maintenance schedule data 202, which can reflect known maintenance dates or scheduled service of certain energy production equipment. In some embodiments, maintenance schedule data 202 can be used to generate or derive period data 110.

In some embodiments, input data 104 can include peak fire criteria data 204. Peak fire criteria data 204 can represent one or more criterion to be satisfied to operate the equipment according to a peak fire protocol. In some embodiments, input data 104 can include equipment data 206. Equipment data 206 can represent information relating to the operation of the energy-producing equipment such as, e.g., fuel consumption rates, energy production rates, settings parameters, status parameters, or other parameters. In some embodiments, input data 104 can include environment data 208. Environment data 208 can represent an environmental condition associated with the equipment or a facility in which the equipment is situated. For example, environment data 208 can reflect an ambient temperature, ambient pressure, ambient humidity or other environmental condition. Environment data 208 can reflect current values, historical values, or forecasted values. It is understood that the above examples are not intended to be limiting, as other suitable data can be included in input data 104.

With specific reference to FIG. 2B, diagram 200B depicts non-limiting examples of market data 112 according to one or more embodiments of the subject disclosure. For example, market data 112 can comprise energy price data 210. Energy price data 210 can represent, e.g., a price of electricity. Such can be based on a market or contractual price. In some embodiments, the price of electricity can be based on a spark spread. The spark spread can represent up-to-the-minute market data that can be listed on an exchange or provided as a financial service. Typically, the spark spread is defined as a price of electricity−(price of gas×heat rate). Thus, in terms of units, the spark spread can represent, e.g., $/MWh−(($/MMBtu)×(MMbtu/MWh)), where $ represents a monetary unit such as dollars, MMBtu represents one million British thermal units, and MWh represents a megawatt-hour or one thousand watt-hours. Energy price data 210 can represent a current price, an historical price, or a projected or forecasted price.

In some embodiments, market data 112 can include fuel cost data 212. Fuel cost data 212 can represent a price of fuel (e.g., gas) consumed by the energy-producing equipment to generate energy. Fuel cost data 212 can represent a current price of fuel, an historic price of fuel, or a forecasted price of fuel. In some embodiments, market data 112 can include load data 214. Load data 214 can represent a load on an energy grid supplied by the equipment or another suitable grid condition. Load data 214 can reflect a current load, a forecasted load, or an historic load. In some embodiments, market data 112 can include weather data 216. Weather data 216 can represent various weather conditions, which can be based on current data, historic data, or a forecast. In addition to the above-mentioned data, market data 112 can include substantially any additional information, which is indicated by other data 218.

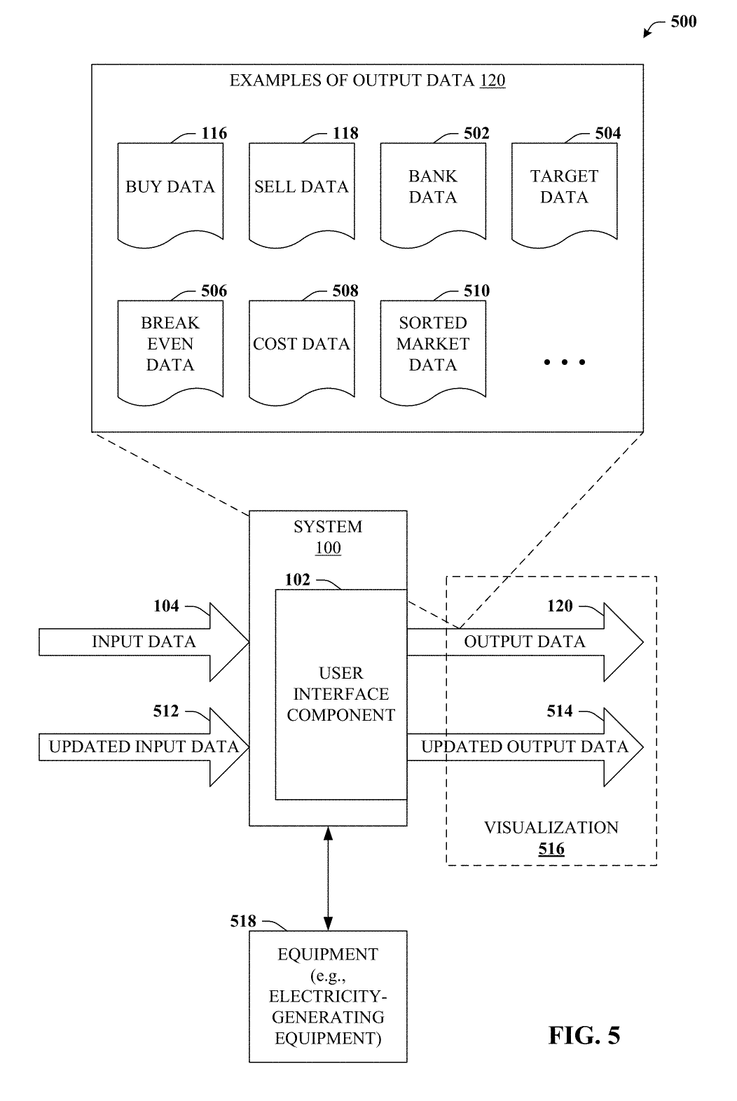

Still referring to FIG. 1, system 100 can further include pricing component 114. Input data 104, whether received via user interface component 102 or data component 108, can be provided to pricing component 114. Pricing component 114 can determine output data 120 based at least in part on input data 104. Output data 120 is further detailed in connection with FIG. 5, but briefly, output data 120 can comprise buy data 116 and sell data 118. Buy data 116 can represent a first price of energy at or below which it can be advised to operate equipment of an energy production facility according to a cold part load protocol. The cold part load protocol can define or specify the equipment is to operate at or below a nominal temperature. It is understood that buy data 116 can represent a value associated with a market-based energy price, or a financial value that is a derivative of or a function of the market-based energy price. Examples can include a strict energy price, a spark spread (which is a function of the energy price), or another energy market pricing instrument. In some embodiments, one or more values surfaced by buy data 116 can be a breakeven point or based on a comparison with the breakeven point. The breakeven value can be computed from performance models or other models to reflect the total costs associated with operating according to the cold part load protocol.

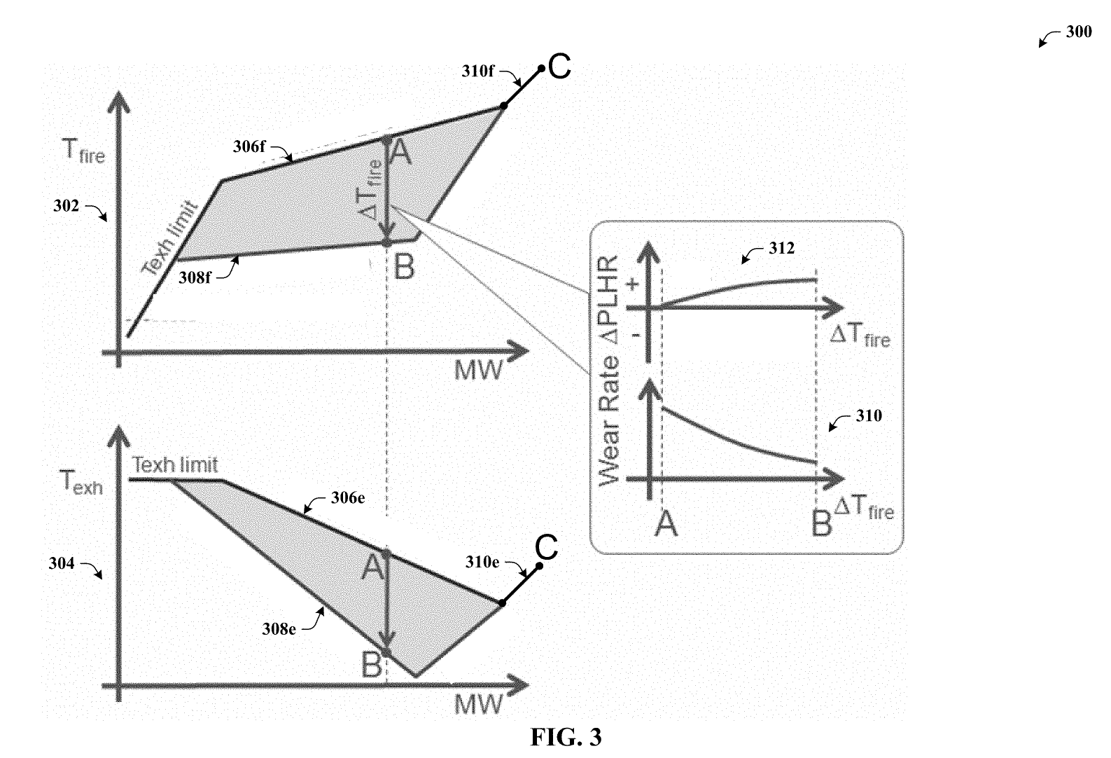

Sell data 118 can represent a second price of energy at or above which it is advised to operate the equipment according to a peak fire protocol. The peak fire protocol can define or specify the equipment is to operate above the nominal temperature. It is appreciated that buy data 116 and sell data 118 can, in some embodiments, represent a translation of very complex physical models relating to operation of energy-production equipment to a simplified financial indicator that can be expressed in terms of financial paradigms. In some embodiments, buy data 116 and sell data 118 and other output data 120 can be provided to or presented by user interface component 102, which is discussed in more detail in connection with FIG. 5. Further detail relating to buy data 116 and sell data 118 as well as various operating characteristics associated with the equipment can be found at FIG. 3.

Turn now to FIG. 3, various graph diagrams are illustrated that depict, inter alia, temperature profiles and wear profiles of energy-producing equipment according to one or more embodiments of the subject disclosure. For example, graph 302 illustrates a graph of fire chamber operating temperature of energy-producing equipment (e.g., a gas turbine) over megawatts produced. Graph 304 illustrates a graph of exhaust apparatus operating temperature of the equipment over megawatts. As is illustrated by graph 302, a nominal temperature profile 306f, a cold temperature profile 308f, and a peak fire temperature profile 310f are depicted. Graph 304 illustrates similar temperature profiles (e.g., 306e, 308e, and 310e) that relate to exhaust temperatures rather than fire temperatures. In some embodiments, temperature profiles 306f and 306e can represent operation of the equipment according to a nominal protocol. In some embodiments, temperature profiles 308f and 308e can represent operation of the equipment according to a cold part load protocol. In some embodiments, the cold part load protocol can include any suitable temperature that is below a nominal value or range. In some embodiments, temperature profiles 310f and 310e can represent operation of the equipment according to a peak fire protocol. In some embodiments, the peak fire protocol can include any suitable temperature that is above a nominal value or range.

In some embodiments, the cold part load protocol can be determined or configured to reduce wear on the equipment. In some embodiments, such as a combined cycle power plant, such reduction of wear (e.g., a reduction relative to operating the equipment at nominal temperatures) that can result, e.g., due to thermodynamics properties, can require more fuel than would be required to operate at the nominal temperature. Thus, the cold part load protocol that reduces wear can come at a cost of increased fuel consumption.

In some embodiments, the peak fire protocol can be determined or configured to increase energy production. In some embodiments, such increased energy production can come at the cost of increased wear on the equipment and increased fuel consumption. Thus, distinct, though substantially predictable trade-offs can exist between operating the equipment according to the nominal protocol, the cold part load protocol, and the peak fire protocol.

FIG. 3 also depicts three example temperatures, labeled “A”, “B”, and “C” that are used for additional explanation. “A” can represent a nominal temperature that can exemplify a target temperature when the equipment is operating according to the nominal protocol. “B” can represent a cold temperature that can exemplify a target temperature when the equipment is operating according to the cold part load protocol. In some embodiments, B can be substantially any temperature that is less than A. “C” can represent a hot temperature that can exemplify a target temperature when the equipment is operating according to the peak fire protocol. In some embodiments, C can be substantially any temperature that is greater than A.

As can be seen, at both nominal temperature, A, and cold temperature, B, the same or similar electricity can be produced. One benefit of operating the equipment at temperature A (e.g., the nominal temperature or in accordance with the nominal protocol) can be reduced fuel consumption to produce the same number of megawatts, as depicted by the lower part load heat rate by graph 312, recognizing that lower heat rate is more efficient, since heat rate indicates the amount of fuel required to produce a unit of electrical energy. On the other hand, one benefit of operating the equipment at temperature B (e.g., the cold temperature or in accordance with the cold part load protocol) can be reduced wear on the equipment, which is illustrated by graph 310 that depicts a wear rate over change in operating temperature. Operating the equipment at temperature C (e.g., a hot temperature or in accordance with the peak fire protocol) can produce more megawatts, but at the cost of increased equipment wear versus nominal or cold operation. In some embodiments, deciding between operation at point A versus point B can depend upon a condition that the unit operating at part load. In some embodiments, deciding whether to operate in peak fire protocol, which might not be applicable at part load, can depend on a condition that the unit is operating at full airflow conditions, or base load.

Referring back to FIG. 1, buy data 116 can represent an indicator of when it can be or is determined to be profitable to operate the equipment according to the cold part load protocol. Although, operation according to the cold part load protocol can increase costs for producing energy, such can represent a mechanism to save or bank additional production at a different time due to the fact that wear rate is reduced, which can be sacrificed to peak fire the equipment at different times (e.g., during favorable market conditions). Likewise, sell data 118 can represent an indicator of when it can be or is determined to be profitable to sacrifice wear by operating according to the peak fire protocol and generating more megawatt-hours.

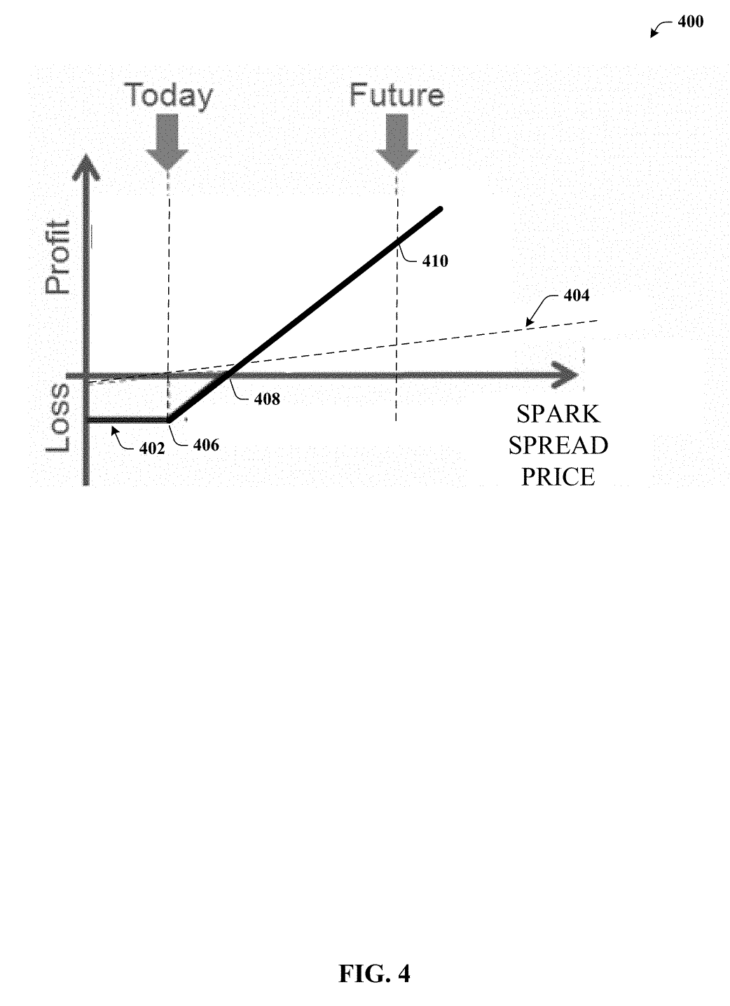

With reference now to FIG. 4, graph 400 is presented. Graph 400 illustrates an example profit-loss profile that compares operating equipment according nominal temperatures to operation according to the buy and sell data according to one or more embodiments of the subject disclosure. Graph 400 depicts profit or loss (e.g., monetary units such as dollars) over spark spread price (e.g., a gross profit margin per MWh of electricity produced). Reference numeral 402 represents an example profit (or loss) profile associated with the disclosed techniques. Such can be contrasted with a profit (or loss) profile associated with operating equipment according to a nominal temperature, which is illustrated by the broken line labeled as profit profile 404. Recall, most energy production facilities today operate equipment continuously at a nominal temperature as such can represent an optimal temperature for fuel consumption per megawatt-hour produced. As illustrated, profit profile 404 shows a gradual increase in profit as the spark spread price increases, which is similar to a return on investment (ROI) achieved with buying stock. That is, a linear relationship with the spark spread with a modest slope.

In contrast, consider profit profile 402, which also has a linear relationship with the spark spread, but boasts a greater slope, and has the ‘hockey stick’ shape that is associated with options instruments, which can be due in part to the fact that significant, options-like leverage can be achieved relative to the simplified view of operating substantially only at the nominal temperature illustrated by profit profile 404. As has been discussed, operating equipment according to the cold part load protocol can be thought of as similar to purchasing an option. Since operating equipment according to the cold part load protocol can require more fuel to maintain the energy output, that additional fuel cost can be thought of as an option purchase price or a strike price or alternatively, a broker commission. Such is illustrated as option price 406, which can be calculated at the time the equipment is operated according to the cold part load protocol, which in this example can be today or a current time. For example, in some embodiments, when the decision is made to operate according to the cold part load protocol, a loss is incurred. However, if the future spark spread never increases above the current spark spread, there is no obligation to exercise (or sell) the option, that is to say there is no obligation to operate according to the peak fire protocol and incur the additional fuel costs to do so. Thus, the loss is fixed, regardless of how low the future spark spread drops, explaining the flat part of the hockey stick shape.

Based on this option price 406, a breakeven price 408 can be determined. Breakeven price 408 can be representative of a cost of extra fuel per MWh generated in some embodiments. At some point in the future, generally, when the spark spread price is much higher, the banked equipment wear can be sacrificed by operating according to the peak fire protocol. As illustrated, profit can be substantially greater, indicative of the leveraged ROI relative to conventional operation.

It is understood that facilities operating mainly according to profit profile 404 (e.g., operating substantially exclusively at nominal temperatures) may also choose to peak fire at times when prices are very high or load is great, but doing so generally will consume equipment life that is not accounted for on the maintenance schedule. While such may result in greater near-term profits, the impact on equipment replacement or service can cause long-term profits to shrink considerably. It is further understood that while profit profile 402 is illustrated and described as banking equipment life initially (e.g., earlier in time) and consuming that banked part life subsequently (e.g., later in time), such can be reversed. For example, depending on market condition, operating according to the peak fire protocol can antecede an associated operation according to the cold part load protocol. Conceptually, such can be thought of as the difference between writing a call and selling a put in options markets parlance.

To provide a concrete example, consider the case in which buy data 116 signals to operate the equipment according to the cold part load protocol, and such operation is implemented for one hour on a day in which the temperature is 70 degrees Fahrenheit. Suppose such operation produces 140 MWh. Further suppose it costs 1% more fuel to operate according to the cold part load protocol. Hence, 0.01*17.35 pounds-mass (lbm)/second*21,515×10⁻⁶ MMBTU/lbm*$2/MMBTU*3600 seconds=$26.88 in extra fuel costs.

Suppose an operational impact factor (OW), representing an impact on wear of the equipment due to suppressed fire temperature, is determined to be 0.38. Such can indicated that a ones complement of the OIF, referred to herein as factored fired hours (FFH) is banked as an available equipment wear metric that is stored for future (or past) use according to the peak fire protocol. Hence, at the cost of an additional $26.88, 0.62 FFH is banked. Suppose a peak load hour consumes 2.24 factored fired hours; then it can be determined that the bank needs to accumulate 1.24 FFH in order to compensate (e.g., in terms of wear) for peak firing operation for a full hour.

In other words, it can be determined, in this example, that for every two hours of operation according to the cold part load protocol, such can enable one hour of operation according to the peak fire protocol, without adding additional wear to the equipment over what would be applied operating the equipment for three hours according to the nominal protocol. Thus, upon completion of the ‘buy’ and ‘sell’ transactions, no net effect is observed with regard to a maintenance schedule or the like. Put differently, in some embodiments, pricing component 114 can determine buy data 116 and sell data 118 based on a condition that a maintenance schedule for the equipment does not change in response to operation according to the cold part load protocol or the peak fire protocol. In some embodiments, pricing component 114 can determine that wear on the equipment that is mitigated by operation of the equipment according to the cold part load protocol is offset by additional wear to the equipment due to operation of the equipment according to the peak fire protocol.

To continue the example above, suppose operation of the equipment according to the peak fire protocol delivers an additional 6.9 MWh combined cycle on a day in which the temperature is 70 degrees Fahrenheit for an additional 0.47 lbm/sec of fuel. In this example, the true costs of operating the equipment according to the cold part load protocol (CPL) for two hours and the peak fire protocol for one hour can be determined according to the following:

$53.76 in extra cold part load fuel cost (e.g., 2×$26.88) plus $72.81 in extra peak fire fuel (e.g., 1 hour @ 0.47 lbm/sec) equals a total additional fuel cost of $126.67. $126.57 divided by 6.9 MWh of incremental power equals 18.34 $/MWh. In other words, the additional 6.9 MWh can be attributed a breakeven cost of $18.34 per MWh. The option price 406 can represent the up-front investment that is incurred by operating for 2 hours at an additional $26.88 fuel cost per hour, or $53.76, which when divided by the 6.9 MWh equals about $8/MWh. Translated to financial paradigms, the above can represent 6.9 MWh in options purchased at 53.76 $/MWh. When the future additional peak fire fuel is considered, 18.34 $/MWh represents a breakeven price (e.g., breakeven price 408). Now suppose the option is ‘sold’ or ‘exercised’ (e.g., the equipment is operated for one hour according to the peak fire protocol to generate the additional 6.9 MWh) in the future at reference numeral 410 when the spark spread price is 54 $/MWh. As illustrated, substantial profits can be achieved. The ROI of this example can be: ROI=exercise price minus breakeven price divided by option cost. Plugging in the numbers, ROI=($54−$18)/$8×100%=450%, which can be substantially more profitable than other operational schemes, for instance, profit profile 402 normally associated with other facilities.

It is understood that ambient temperatures and numerous other factors between the day of purchase and the day of exercise can affect the determined values, but in this simplified example, such factors are considered the same or otherwise negligible. For instance, this example assumes it is 70 degrees both days, which in practice will not always be the case.

With reference now to FIG. 5, there is illustrated an example system 500. System 500 can provide various visualization of output data and can optionally control energy production equipment according to one or more embodiments of the subject disclosure. System 500 can include all or a portion of system 100. As discussed, system 100 can receive input data 104 and, in response, determine output data 120. Output data can comprise buy data 116 and sell data 118, detailed in connection with FIG. 1.

In some embodiments, output data 120 can include bank data 502. Bank data 502 can represent a running balance of peak fire opportunities that accumulate in response to operating the equipment (e.g., equipment 518) according to the cold part load protocol. For example, pricing component 114 can update (e.g., credit or increment) bank data 502 in response to operating equipment 518 according to the cold part load protocol. As another example, pricing component 114 can update (e.g., debit or decrement) bank data in response to operating equipment 518 according to the peak fire protocol. In some embodiments, if a value associated with bank data 502 is positive, then peak fire opportunities have been stored and equipment 518 likely has less wear than expected by an associated maintenance schedule. A negative value of bank data 502 can reflect that more peak fire opportunities have been consumed that have, to this point, been stored and equipment 518 likely has more wear than expected by an associated maintenance schedule. A value of zero can reflect that all options have been exercised (e.g., all operation according to cold part load protocol has been offset by operation according to peak fire protocol) and wear on the equipment 518 is in accord with the maintenance schedule. Given the above, it can be desirable to target a bank value of zero prior to a service or replacement data of equipment 518.

In some embodiments, output data 120 can include target data 504. Target data 504 can represent a target amount of peak fire opportunities to be stored or targeted for storage. Target data 504 can differ from bank data 502 in that target data 504 need not be offset or decremented in response to operating equipment 518 according to the peak fire protocol. Rather, target data 504 can represent a total number of peak fire opportunities to be stored over during some defined period such as a service or replacement date of equipment 518, or some time before that date, which can be determined based on period data 110. In some embodiments, target data 504 can be further determined in response to a determined marginal profit margin of operating equipment 518 according to the cold part load protocol being less than a threshold profit margin (e.g., profit margin data 106).

In other words, target data 504 can reflect a total number of options (e.g., stored peak fire opportunities) that should be purchased, while also limiting risk to only those purchases in which it can be determined to be likely that a minimum profit margin can be achieved. It can be observed that buying too few options can result in missed opportunities, but on the other hand, buying too many can result in increased risk of not being able to sell or exercise the option before the maintenance date or another time that represents the expiration.

By way of illustration and not limitation, consider an example in which a user inputs 30% as part of profit margin data 106, which can indicate that pricing component 114 determine target data 504 such that each banked peak fire opportunity can be ‘sold’ with a profit of at least 30% given expected market conditions and other factors that can be determined based on, e.g., market data 112.

In some embodiments, output data 120 can include breakeven data 506. Breakeven data 506 can represent a breakeven price associated with purchase of a spark option or the cost of operating equipment 518 according to the cold part load protocol in order to store a peak fire opportunity. An example of breakeven data 506 can be breakeven price 408 of FIG. 4. In some embodiments, output data 120 can include cost data 508. Cost data 508 can represent costs of operating equipment 518 according to the cold part load protocol. In some embodiments, cost data 508 can be sorted and visualized in sorted order, such as in ascending order or descending order. In some embodiments, output data 120 can include sorted market data 510. Sorted market data 510 can represent market data 114 that is sorted such as sorted in ascending order or sorted in descending order. It is understood that other examples of output data 120 can exist. For example, all or portions of market data 114 (e.g., unsorted or sorted chronologically) can be included in output data 120.

In some embodiments, input data 104 can be updated or different sets of input data 104 can be selected, which is represented herein as updated input data 512. In some embodiments, pricing component 114 can update output data 120 in response to changes to input data 104. In other words, if input data 104 changes, which can be represented by updated input data 512, then output data 120 can exhibit a corresponding change, which can be represented by updated output data 514.

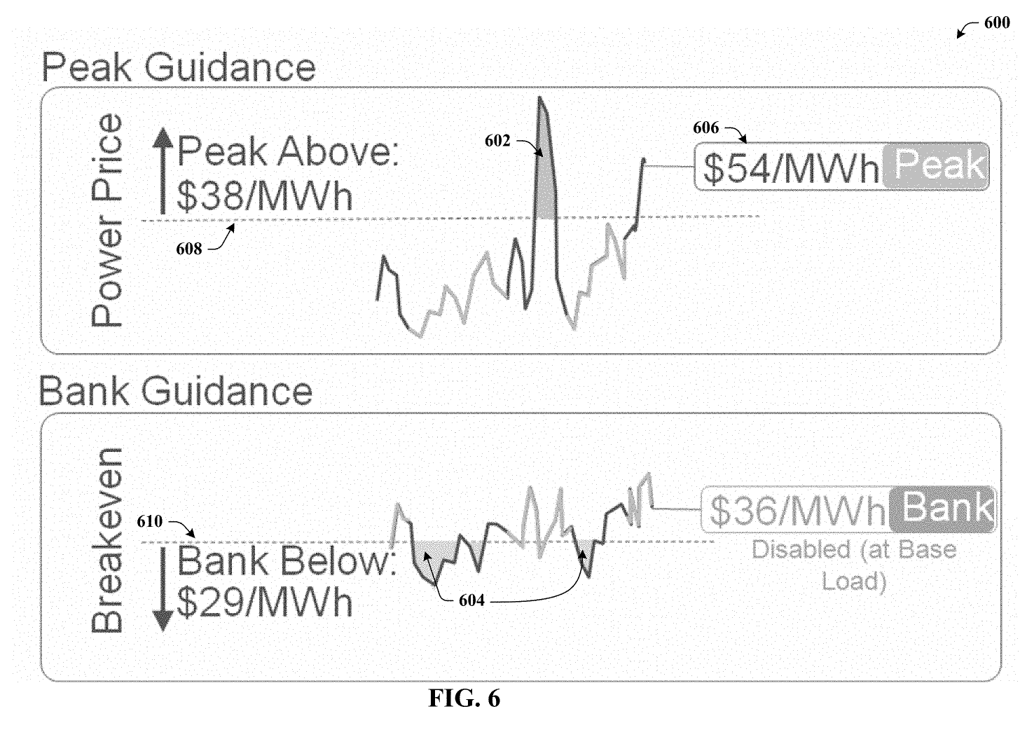

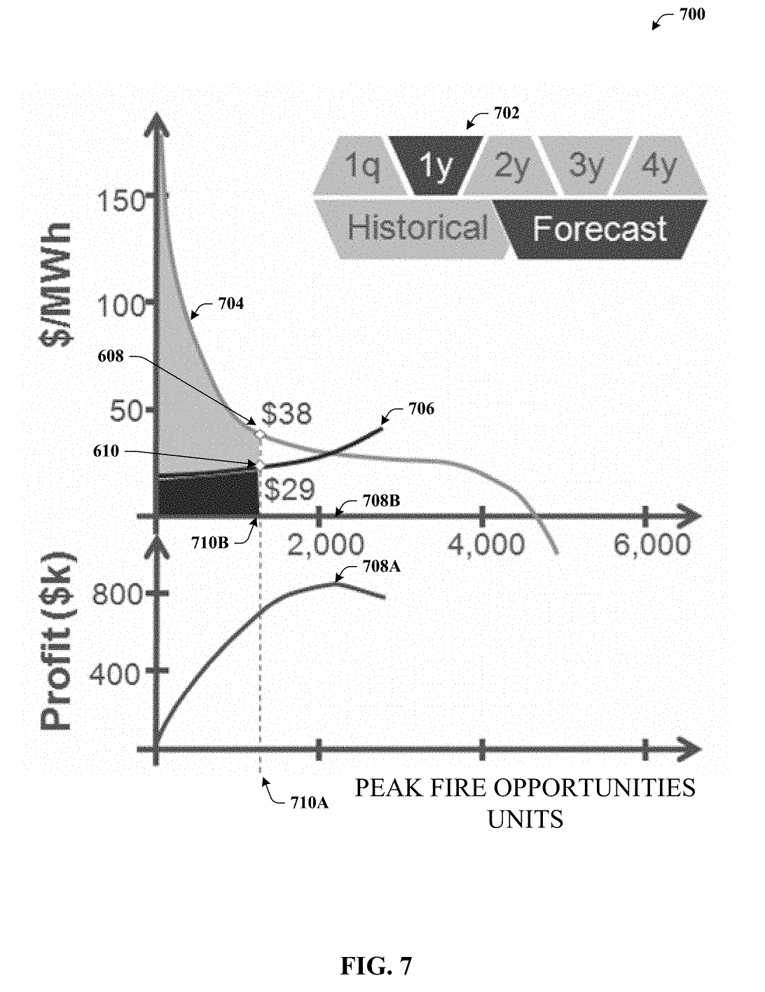

In some embodiments, output data 120 or updated output data 514 can be presented (e.g., via user interface 102), such as according to visualization 516. FIGS. 6 and 7 represent various non-limiting examples of visualization 516.

Turning now to FIG. 6, graph 600 is depicted. Graph 600 illustrates market-based electricity prices and determined equipment operation triggers according to one or more embodiments of the subject disclosure. Graph 600 depicts electricity price over time. As can be seen, electricity prices can vary significantly over the time, which can yield various opportunities as detailed herein. In this example, areas of the graph shaded dark gray, and labeled with reference numeral 602, can be indicative of market conditions in which it can be profitable to operate according to the peak fire protocol. In financial terms, such can signify determined sell or exercise opportunities for a spark option. Areas of the graph shaded light gray, and labeled with reference numeral 604, can be indicative of market condition in which it can be profitable to operate according to the cold part load protocol. In financial terms, such can signify determined buy opportunities for a spark option.

In this example, the sell opportunities occur when the electricity price is above $38/MWh, labeled here as reference numeral 608. Sell opportunities can be determined as sell data 118. Certain buy opportunities can occur when the spark option breakeven price is below $29/MWh, labeled here as reference numeral 610. Buy opportunities can be determined as buy data 116. In this example, a current electricity price 606 is $54/MWh while operating at base load. In this scenario, the advice to sell, e.g., peak fire, can be provided. Since in this example the plant is a base load, rather than part load, it is generally not possible to buy a spark option, e.g., operate according to the cold part load protocol, hence the advice to “buy” is greyed out.

Referring now to FIG. 7, visualization 700 is illustrated. Visualization 700 illustrates sorted market-based electricity prices, sorted cost data, and projected profits according to one or more embodiments of the subject disclosure. Visualization 700 can be an example of visualization 516 that can be presented by user interface component 102.

In visualization 700, period data 110 can be selected via a user interface element 702. In this example, a timeframe of one year is selected, but other timeframes can be selected and the selection can represent period data 110. User interface element 702 can also be used to select the type of market data 112 that is to be used to determine various output data 120 such as historical data (e.g., past data used as a proxy for future data such as prices or conditions) or forecasted data (e.g., using models to forecast future data such as prices or conditions).

Curve 704 can represent the forecasted market prices for electricity (e.g., illustrated in FIG. 6), but sorted in descending order instead of being shown in chronological order. Curve 706 can represent spark option breakeven prices (e.g., breakeven data 506) sorted in ascending order. Such costs can include costs (e.g., additional fuel costs) associated with operating the energy-producing equipment according to the cold part load protocol or according to the peak fire protocol.

Based on input data 120 detailed herein sell opportunities 608 can exist at or above a price of $38/MWh and buy opportunities 610 can exist at or below a price of $29/MWh, which can be determined as sell data 118 and buy data 116, respectively. Prices between those two values can be considered hold recommendations in which the equipment is operated according to a nominal protocol or is operated at neither the cold part load protocol nor the peak fire protocol.

As can be seen at 708A, a theoretical maximum profit can be attained at a point in which curve 704 and curve 706 cross. Such can be determined to represent a target number of purchased spark options of about 2100 units of peak fire opportunities, illustrated by 708B. This target number can represent one example of target data 504 in the case where no minimum profit margin was indicated. It is understood that attempting to capture the theoretical maximum profit can be a risky proposition, as much of input data 104 can be forecasted based on modeled estimates or the like.

Hence, in another example, profit margin data 106 can indicate minimum expected profit margin of 30%, illustrated at reference numeral 710A. Such can build in risk-tolerance at the cost of not capturing potential profits up to the theoretical maximum profit. It is noted that the value (e.g., $38) of sell data 116 is 30% higher than the value (e.g., $29). In this case, target data 504 can be about 1100 units, illustrated at reference numeral 710B. In some embodiments, peak fire opportunities can be expressed in units of hours of operation of the equipment according to the peak fire protocol or the cold part load protocol. In some embodiments, peak fire opportunities can be expressed in units of megawatt-hours of energy produced by the equipment operating according to the peak fire protocol.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

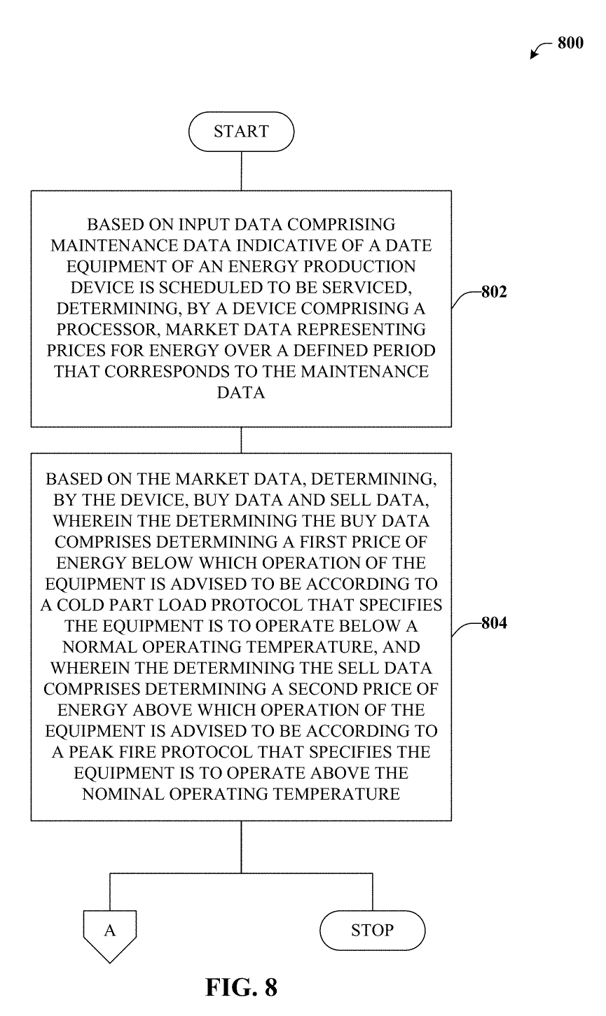

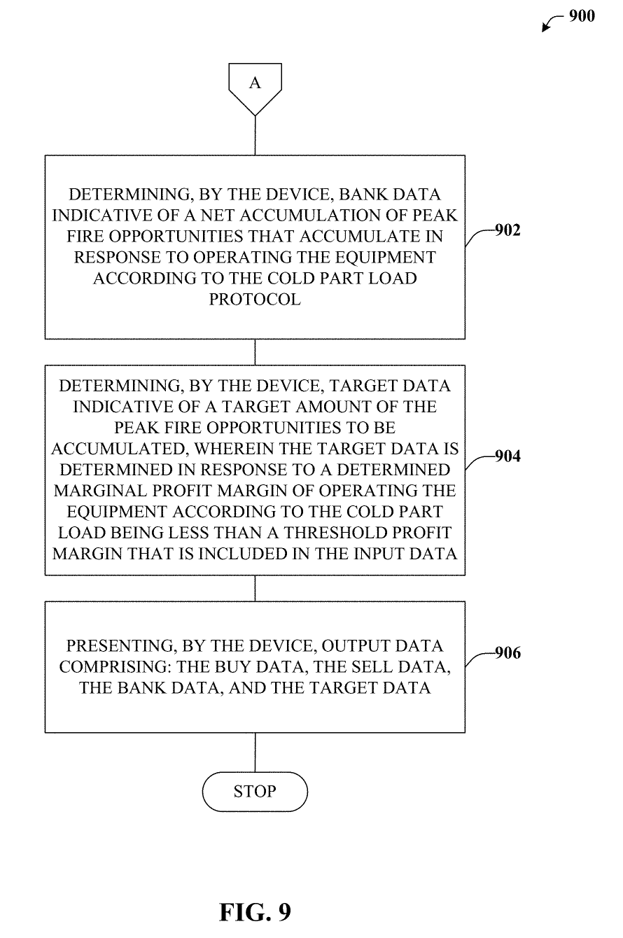

FIGS. 8-9 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 8, there illustrated is a methodology 800 for determining buy and sell data that reflect financial opportunities based on underlying operational characteristics of energy-producing equipment according to one or more embodiments of the subject disclosure. As an example, the methodology 800 can be utilized in various applications relating to controlling or operating energy production facilities or equipment. At reference numeral 802, a device comprising a processor can determine market data representing prices for energy over a defined period that corresponds to the maintenance data. Such a determination can be made based on input data. The input data can comprise maintenance data indicative of a date equipment of an energy production device is scheduled to be serviced.

At reference numeral 804, the device can determine buy data and sell data based on market data. Determining the buy data can comprise determining a first price of energy below which operation of the equipment is advised to be according to a cold part load protocol. The cold part load protocol can specify the equipment is to operate below a normal operating temperature. Determining the sell data can comprise determining a second price of energy above which operation of the equipment is advised to be according to a peak fire protocol. The peak fire protocol can specify the equipment is to operate above the nominal operating temperature. Method 800 can end or proceed to insert A, which is further detailed at FIG. 9.

Turning now to FIG. 9, there illustrated is a methodology 900 for providing additional aspect or elements in connection with determining buy and sell data according to one or more embodiments of the subject disclosure. At reference numeral 902, the device can determine bank data. Bank data can be indicative of a net accumulation of peak fire opportunities that accumulate in response to operating the equipment according to the cold part load protocol.

At reference numeral 904, the device can determine target data. Target data can be indicative of a target amount of the peak fire opportunities to be accumulated. In some embodiments, the target data can be determined in response to a determined marginal profit margin of operating the equipment according to the cold part load being less than a threshold profit margin that is included in the input data.

At reference numeral 906, the device can present the output data. Presentation of the output data can comprise a presentation of the buy data, the sell data, the bank data, and the target data, as well as other types of data detailed herein or otherwise suitable.

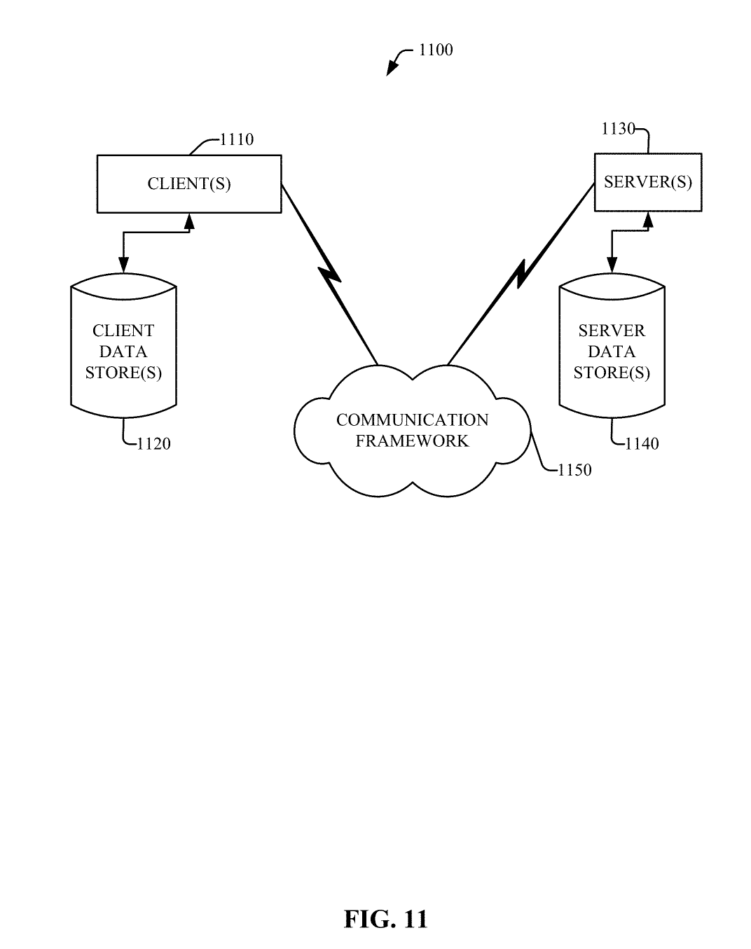

In order to provide a context for the various aspects of the disclosed subject matter, FIGS. 10 and 11 as well as the following discussion are intended to provide a brief, general description of a suitable environment in which the various aspects of the disclosed subject matter may be implemented.

With reference to FIG. 10, a suitable environment 1000 for implementing various aspects of this disclosure includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 also includes removable/non-removable, volatile/nonvolatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used, such as interface 1026.

FIG. 10 also depicts software that acts as an intermediary between users and the basic computer resources described in the suitable operating environment 1000. Such software includes, for example, an operating system 1028. Operating system 1028, which can be stored on disk storage 1024, acts to control and allocate resources of the computer system 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the subject matter of this disclosure can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing this disclosure, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1120 that can be employed to store information local to the client(s) 1110. Similarly, the server(s) 1130 are operatively connected to one or more server data store(s) 1140 that can be employed to store information local to the servers 1130.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory that stores computer executable components;
a processor that executes computer executable components stored in the memory, wherein the computer executable components comprise:
a user interface component that receives a first portion of input data comprising profit margin data that represents a threshold profit margin;
a data component that receives a second portion of input data comprising period data that represents a defined period of time and market data representing prices for energy over the defined period of time; and
a pricing component that determines buy data and sell data based on the market data and the profit margin data, wherein the buy data represents a first price of energy below which it is advised to operate equipment of an energy production facility according to a first protocol that is determined to reduce wear on the equipment relative to nominal operation, and wherein the sell data represents a second price of energy above which it is advised to operate the equipment according to a second protocol that is determined to increase wear on the equipment relative to the nominal operation.

2. The system of claim 1, wherein the first protocol is a cold part load protocol that specifies the equipment is to operate below a nominal temperature, and wherein the second protocol is a peak fire protocol that specifies the equipment is to operate above the nominal temperature.

3. The system of claim 2, wherein cold part load protocol is configured to reduce wear on the equipment at the cost of increased fuel consumption, and wherein the peak fire protocol is configured to increase energy production capacity of the equipment at the cost of increased wear on the equipment.

4. The system of claim 2, wherein the pricing component updates bank data representing a running balance of peak fire opportunities that accumulate in response to operating the equipment according to the cold part load protocol.

5. The system of claim 4, wherein the pricing component further determines target data that represents a target amount of the peak fire opportunities to be targeted within the defined period of time, and wherein the target data is determined in response to a determined marginal profit margin of operating the equipment according to the cold part load protocol being less than the threshold profit margin.

6. The system of claim 5, wherein the peak fire opportunities are expressed in units selected from a group comprising: hours of operation of the equipment according to the peak fire protocol and megawatt-hours of energy produced by the equipment operating according to the peak fire protocol.

7. The system of claim 5, wherein the user interface component presents output data expressed in terms of options market trading, wherein the output data comprises: the buy data, the sell data, the bank data, and the target data.

8. The system of claim 7, wherein the output data further comprises costs of operating the equipment according to the cold part load protocol sorted in ascending order and the prices for energy over the defined period sorted in descending order.

9. The system of claim 7, wherein the user interface component updates the output data in response to a first change to the input data or in response to a second change to the market data.

10. The system of claim 2, wherein the input data further comprises data selected from a group comprising: an historical price of electricity, a current price of electricity, a determined forecasted price of electricity, an historical price of fuel the equipment consumes to produce electricity, a current price of fuel, a determined forecasted price of fuel, an historical ambient temperature or environment condition of the equipment, a current ambient temperature or condition, a determined forecasted ambient temperature or condition, an historical load on an energy network supplied by the equipment, a current load, a determined forecasted load, maintenance schedule data representing scheduled service of the equipment, peak fire criteria data representing a criterion to be satisfied to operate the equipment according to the peak fire protocol, and equipment data representing information relating to operation of the equipment.

11. The system of claim 2, wherein the pricing component determines the buy data and the sell data based on a condition that a maintenance schedule for the equipment does not change in response to operation according to the cold part load protocol or the peak fire protocol.

12. The system of claim 11, wherein the pricing component determines that wear of the equipment that is mitigated by operation of the equipment according to the cold part load protocol is offset by additional wear to the equipment due to operation of the equipment according to the peak fire protocol.

13. A method, comprising:
based on input data comprising maintenance data indicative of a date equipment of an energy production device is scheduled to be serviced, determining, by a device comprising a processor, market data representing prices for energy over a defined period that corresponds to the maintenance data; and
based on the market data, determining, by the device, buy data and sell data, wherein the determining the buy data comprises determining a first price of energy below which operation of the equipment is advised to be according to a first protocol that is determined to reduce wear on the equipment, and wherein the determining the sell data comprises determining a second price of energy above which operation of the equipment is advised to be according to a second protocol that is determined to increase wear on the equipment.

14. The method of claim 13, further comprising determining, by the device, bank data indicative of a net accumulation of second protocol opportunities that accumulate in response to operating the equipment according to the first protocol.

15. The method of claim 14, further comprising determining, by the device, target data indicative of a target amount of the second protocol opportunities to be accumulated, wherein the target data is determined in response to a determined marginal profit margin of operating the equipment according to the first protocol being less than a threshold profit margin that is included in the input data.

16. The method of claim 15, further comprising presenting, by the device, output data comprising: the buy data, the sell data, the bank data, and the target data.

17. A computer-readable medium, comprising executable instructions that, when executed by a processor, facilitate performance of operations, comprising:
determining market data representing prices for energy over a defined period;
determining buy data based on the market data, wherein the buy data represents a first price of energy below which it is advised to operate equipment of an energy production facility according to a first protocol that is configured to reduce wear on the equipment;
determining sell data based on the market data, wherein the sell data represents a second price of energy above which it is advised to operate the equipment according to a second protocol that is configured to increase wear on the equipment; and
facilitating presentation of the buy data and the sell data via a user interface device.

18. The computer-readable medium of claim 17, further comprising, determining the defined period as a period of time between a first date and a second date, wherein the second date is indicative of a date at which the equipment is scheduled for service.

19. The computer-readable medium of claim 17, further comprising, facilitating presentation, via the user interface device, of target buy data representing a target amount of second protocol opportunities to be created in response to operating the equipment according to the first protocol.

20. The computer-readable medium of claim 17, further comprising, facilitating presentation, via the user interface device, of the market data that is sorted according to energy price and cost data representing a cost in increased fuel consumption of operating the equipment according to the first protocol, wherein the cost data is sorted according to cost.
